(19) United States
(12) Patent Application Publication
(10) Pub. No.: US 2017/0279764 A1
(43) Pub. Date: Sep. 28, 2017

(54) COMMUNICATION CONTROL APPARATUS, METHOD, AND RECORDING MEDIUM FOR DHCP

(71) Applicant: NEC Corporation, Tokyo (JP)

(72) Inventor: Tomohiro NISHIKAWA, Tokyo (JP)

(73) Assignee: NEC Corporation, Tokyo (JP)

(21) Appl. No.: 15/455,319

(22) Filed: Mar. 10, 2017

(30) Foreign Application Priority Data
Mar. 23, 2016 (JP) 2016-058068

(51) Int. Cl. H04L 29/12

(52) U.S. Cl. CPC H04L 61/2015; H04L 61/6022

(57) ABSTRACT

A communication control apparatus of the present invention includes a receiver that receives a dynamic host configuration protocol (DHCP) discover message from a communication apparatus arranged in a subscriber network, and a processor that selects an IP address for the communication apparatus on the basis of vendor-related information included in the DHCP discover message.

This application is based upon and claims the benefit of priority from Japanese patent application No. 2016-058068, filed on Mar. 23, 2016, the disclosure of which is incorporated herein in its entirety by reference.

### TECHNICAL FIELD

The present invention relates to a communication control apparatus, a method, and a recording medium for a dynamic host configuration protocol (DHCP).

### BACKGROUND ART

DHCP is a protocol for automatically assigning required information such as an internet protocol (IP) address to a communication apparatus connected to a network. For example, a broadband router located in a home supports DHCP and operates as a DHCP server. In this case, since a DHCP server exists in a home, each subscriber can assign a specific IP address to a specific customer premises equipment (CPE) through DHCP.

For example, a solution regarding assignment of IP addresses according to DHCP is disclosed in Patent Literature 1 (PTL1).

[PTL 1] Japanese Laid-open Patent Publication No. 2012-134859

### SUMMARY

An example object of the present invention is to enable assignment of a specific IP address to a specific communication apparatus even when a DHCP server is not arranged in a subscriber network.

A communication control apparatus according to an example aspect of the present invention includes: a receiver that receives a dynamic host configuration protocol (DHCP) discover message from a communication apparatus arranged in a subscriber network; and a processor that selects an IP address for the communication apparatus on the basis of vendor-related information included in the DHCP discover message.

A method according to an example aspect of the present invention includes: acquiring vendor-related information included in a DHCP discover message from a communication apparatus arranged in a subscriber network; and selecting an IP address for the communication apparatus on the basis of the vendor-related information.

A non-transitory computer readable recording medium according to an example aspect of the present invention is a recording medium storing a program that causes a processor to execute: acquiring vendor-related information included in a DHCP discover message from a communication apparatus arranged in a subscriber network; and selecting an IP address for the communication apparatus on the basis of the vendor-related information.

### BRIEF DESCRIPTION OF THE DRAWINGS

FIG. 1 is an explanatory diagram for describing an example of a case in which a DHCP server exists in a home.

FIG. 2 is an explanatory diagram illustrating an example of a schematic configuration of a system according to a first example embodiment.

FIG. 3 is a block diagram illustrating an example of a schematic configuration of a DHCP server according to the first example embodiment.

FIG. 4 is a sequential chart for describing an example of a flow of processing according to the first example embodiment.

FIG. 5 is a block diagram illustrating an example of a schematic configuration of a communication control apparatus according to a second example embodiment.

FIG. 6 is a sequential chart for describing an example of a flow of processing according to the second example embodiment.

### EXAMPLE EMBODIMENT

Hereinafter, the example embodiments of the present invention are described in detail with reference to accompanying drawings. In the present description and drawings, redundant description may be omitted by providing the same numeral references for the elements which can be described in the similar manner.

Description is given in the following order.

1. Summary of example embodiments of the present invention

2. First example embodiment

2.1. Configuration of system

2.2. Configuration of DHCP server

2.3. Flow of processing

2.4. Application examples

3. Second example embodiment

3.1. Configuration of communication control apparatus

3.2. Flow of processing

### 1. Summary of Example Embodiments of the Present Invention

First, summary of the example embodiments of the present invention is described.

### (1) Technical Problem

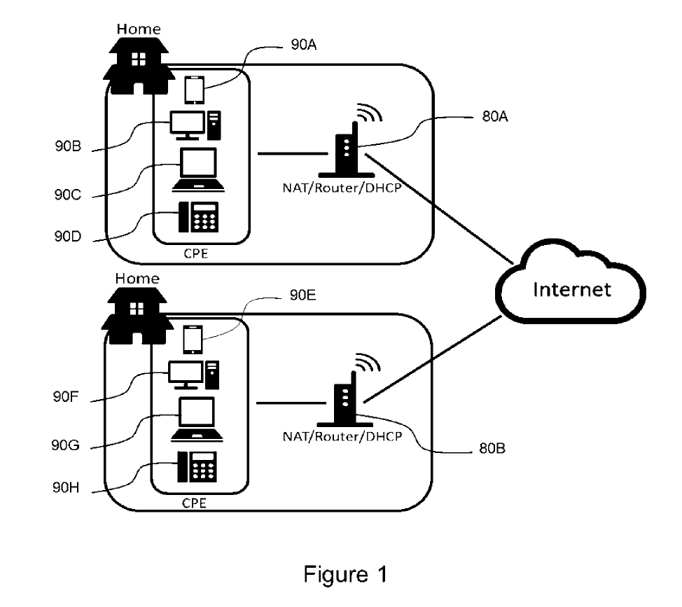

For example, as illustrated in FIG. 1, a broadband router 80 arranged in a home supports DHCP, and operates as a DHCP server. In this case, each subscriber can assign a specific IP address to a specific CPE 90 through DHCP since the DHCP server exists in the home.

In a virtual CPE (vCPE) system, a DHCP server is arranged in a carrier network. Therefore, in order to assign a specific IP address to a specific CPE in the vCPE system, a carrier needs to manually set a specific IP address to a specific CPE for all the subscribers. In automatic IP address assignment of DHCP, a range of IP addresses to be assigned is determined in advance, and an IP address within the range is assigned. Therefore, it is difficult to set a specific IP address to a specific CPE automatically.

The example embodiments of the present invention makes it possible to assign a specific IP address to a specific communication apparatus (for example, a specific CPE) even when a DHCP server is not arranged in a subscriber network.

### (2) Technical Feature

In the example embodiments of the present invention, for example, on the basis of vendor-related information included in a DHCP discover message from a communication apparatus (for example, a CPE) arranged in a subscriber network, a DHCP server selects an IP address for the communication apparatus.

This makes it possible to assign a specific IP address to a specific communication apparatus (for example, a specific CPE) even when the DHCP server is not arranged in the subscriber network.

Note that the technical feature mentioned above is a concrete example of the example embodiments of the present invention, and it is needless to say that the example embodiments of the present invention is not limited to the technical feature mentioned above.

### 2. First Example Embodiment

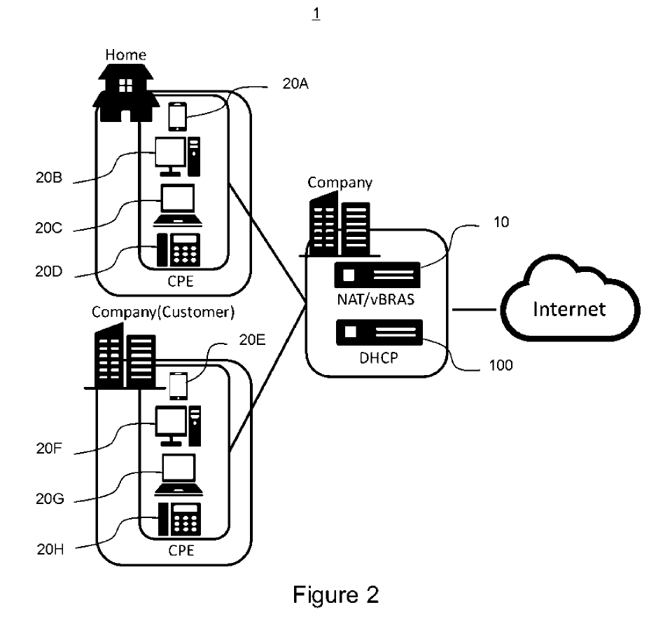

Next, a first example embodiment of the present invention is described with reference to FIG. 2 to FIG. 4.

### <2.1. System Configuration>

First, with reference to FIG. 2, an example of a configuration of a system 1 according to the first example embodiment is described. FIG. 2 is an explanatory diagram illustrating an example of a schematic configuration of the system 1 according to the first example embodiment. Referring to FIG. 2, the system 1 includes a DHCP server 100, a network address translation (NAT)/virtual broadband remote access server (vBRAS) server 10, and one or more CPEs 20. For example, the system 1 may be called a vCPE system.

The DHCP server 100 and the NAT/vBRAS server 10 are arranged in a carrier network. The DHCP server 100 and the NAT/vBRAS server 10 may be implemented as separate apparatuses, and may be implemented as a single apparatus. Alternatively, each of the DHCP server 100 and the NAT/vBRAS server 10 may be implemented as a virtual machine which operates on a physical apparatus (and the physical apparatus).

Each CPE 20 is arranged in a subscriber network (for example, an in-home network or an in-enterprise network). Here, each CPE 20 is, for example, user equipment (UE), such as a personal computer (PC), a telephone, a mobile phone, or a smartphone. For example, CPEs 20 communicate with an apparatus (for example, the DHCP server 100, NAT/vBRAS server 10 or the like) arranged in the carrier network through communication equipment (for example, equipment having a layer 2 function) arranged in the subscriber network. The above-mentioned communication equipment may be called an L2 CPE. Alternatively, the CPE 20 itself may be the communication equipment (for example, the L2 CPE) arranged in the subscriber network.

Each CPE 20 may operate as a DHCP client. Therefore, each CPE 20 can also be called the DHCP client. For example, each CPE 20 transmits a DHCP discover message, and in response to the message, the DHCP server 100 selects an IP address for the CPE 20, and transmits a DHCP offer message including the IP address. Further, for example, in order to report that the above-mentioned IP address does not include any problem, the CPE 20 transmits a DHCP request message, and the DHCP server 100 transmits, in response to the message, a DHCP acknowledge (ACK) message.

The NAT/vBRAS server 10 provides a NAT and remote access service to the CPEs 20.

This allows the CPEs 20 to communicate through the Internet, for example.

### <<2.2. Configuration of DHCP Server>>

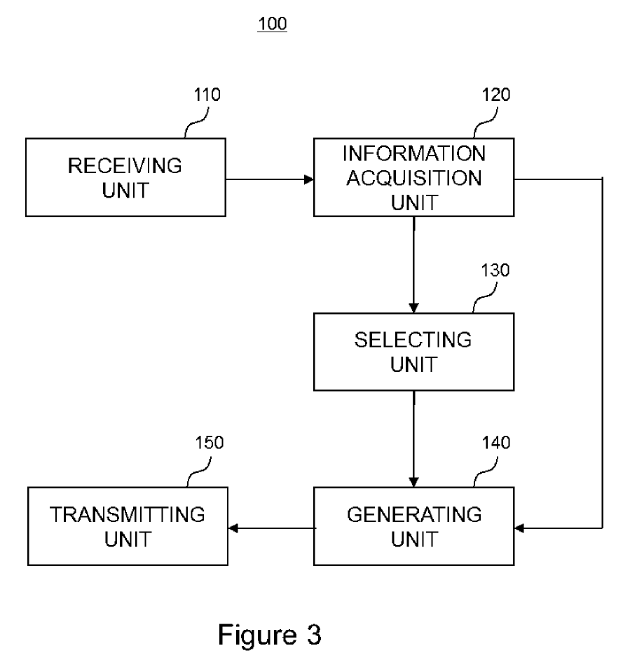

Next, with reference to FIG. 3, an example of a configuration of the DHCP server 100 according to the first example embodiment is described. FIG. 3 is a block diagram illustrating an example of a schematic configuration of the DHCP server 100 according to the first example embodiment. Referring to FIG. 3, the DHCP server 100 includes a receiving unit (receiver) 110, an information acquisition unit (information acquirer) 120, a selecting unit (selector) 130, a generating unit (generator) 140, and a transmitting unit (transmitter) 150.

### (1) Receiving Unit 110

The receiving unit 110 receives the DHCP discover message from any of the CPEs 20.

Moreover, for example, the receiving unit 110 receives the DHCP request message from any of the CPEs 20.

### (2) Information Acquisition Unit 120

The information acquisition unit 120 acquires vendor-related information included in the DHCP discover message from the CPE 20.

For example, the vendor-related information includes vendor-specific information for identifying a vendor. More specifically, for example, the vendor-specific information is a vendor-identifying vendor-specific information option which is option 125 of the DHCP discover message.

For example, the vendor-related information includes a vendor class identifier. More specifically, the vendor class identifier is a vendor class identifier which is option 60 of the DHCP discover message, for example.

Option 60 and option 125 of the DHCP discover message are described in DHCP RFC 3925.

### (3) Selecting Unit 130

The selecting unit 130 selects an IP address for the CPE 20 on the basis of the above-mentioned vendor-related information.

For example, the selecting unit 130 determines whether the CPE 20 is a target apparatus on the basis of the above-mentioned vendor-related information (for example, option 125 (and option 60)). Then, the selecting unit 130 selects the IP address on the basis of the determination result.

More specifically, when the CPE 20 is the target apparatus, the selecting unit 130 selects a specific IP address corresponding to the CPE 20 as the above-mentioned IP address, for example. For example, the DHCP server 100 stores information on the relationship between the target apparatus (or a group of target apparatuses) and an associated IP address, e.g., in a memory, and selects the IP address associated with the CPE 20 (target apparatus) on the basis of this information.

On the other hand, for example, when the CPE 20 is not a target apparatus, the selecting unit 130 selects an IP address within a predetermined range as the above-mentioned IP address. For example, the selecting unit 130 selects an arbitrary unused IP address within the predetermined range.

### (4) Generating Unit 140

The generating unit 140 generates the DHCP offer message including the selected IP address.

For example, the generating unit 140 generates a DHCP ACK message in response to the DHCP request message from the CPE 20.

### (5) Transmitting Unit 150

The transmitting unit 150 transmits the above-mentioned DHCP offer message.

Moreover, for example, the transmitting unit 150 transmits the above-mentioned DHCP ACK message.

For example, each of the receiving unit 110 and the transmitting unit 150 may be implemented by a receiving/transmitting circuit, a network interface device, an antenna, a radio frequency (RF) circuit and/or a baseband processor, and the like. The information acquisition unit 120, the selecting unit 130, and/or the generating unit 140 may be implemented by a processor and a memory (and a program stored in the memory).

### <2.3. Flow of Processing>

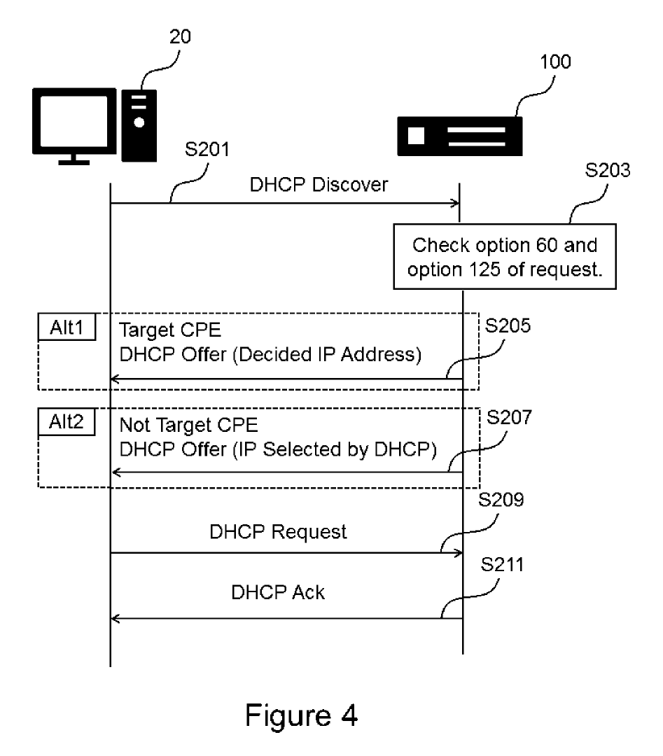

Next, with reference to FIG. 4, an example of a flow of processing according to the first example embodiment is described. FIG. 4 is a sequential chart for describing the example of the flow of processing according to the first example embodiment.

The CPE 20 transmits a DHCP discover message (S201). The DHCP server 100 acquires and checks option 60 and option 125 included in the above-mentioned DHCP discover message (S203). Specifically, the CPE 20 determines whether the CPE 20 is a target apparatus (target CPE) on the basis of option 60 and option 125.

When the CPE 20 is the target apparatus (target CPE), the DHCP server 100 selects a specific IP address associated with the CPE 20, generates and transmits a DHCP offer message including the specific IP address (S205).

When the CPE 20 is not the target apparatus (target CPE), the DHCP server 100 selects an IP address within a predetermined range, and generates and transmits a DHCP offer message including the IP address (S207).

The CPE 20 transmits a DHCP request message in order to report that the above-mentioned IP address has no problem (S209).

The DHCP server 100 transmits a DHCP ACK message in response to the above-mentioned DHCP request message (S211).

Then, the CPE 20 sets the above-mentioned IP address.

In the above, the first example embodiment (except for application examples) has been described. According to the first example embodiment, it possible to assign a specific IP address to a specific CPE (target apparatus) even when a DHCP server is not arranged in a subscriber network (for example, even when the DHCP server is arranged in a carrier network).

### <2.4. Application Examples>

Next, application examples of the first example embodiment are described. Specifically, carriers can carry out the following operations by assigning a specific IP address to a specific CPE (target apparatus) as mentioned above.

### (1) First Application Example

For example, when a failure or a setting error occurs in the specific CPE (target apparatus), a carrier can collect information on the specific CPE and/or change the setting of the specific CPE, and the like, from a center of the carrier without investigating the IP address assigned to the specific CPE. Therefore, the operation cost (OPEX) of the carrier may be reduced.

### (2) Second Application Example

For example, in an enterprise vCPE system, central management of IP addresses for all the bases (all the places of business) can be easily conducted by assigning IP addresses for each product type of CPEs.

It is possible to perform efficient software update and/or firmware update or the like at the same time (from a center of a carrier, or the like), by assigning IP addresses which are common in all the bases to equipment in each base (for example, a facsimile, a printing machine, a copy machine, a storage).

From these effects, the operation cost (OPEX) of the carrier may be reduced.

### (3) Third Application Example

When an unknown notebook PC or PC tries to establish a connection with an in-enterprise network, a DHCP server can distinguish CPEs and prevent from assigning an IP address to the unknown PC. This effect may improve security.

When a visitor's CPE (for example, a notebook PC) establishes a connection through an intranet in a company, it is possible to distinguish CPEs and assign an IP address of a closed network in the company to the visitor's CPE, not establishing a connection of the visitor's CPE with the Internet outside the company without distinguishing CPEs. This effect may improve security for the visitor's CPE.

### 3. Second Example Embodiment

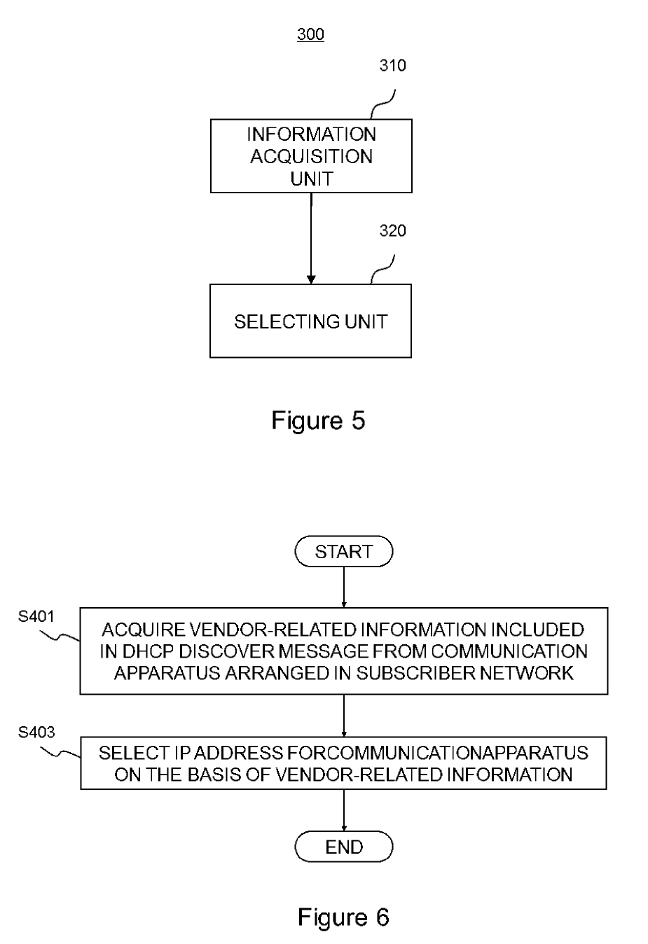

Next, a second example embodiment of the present invention is described with reference to FIG. 5 and FIG. 6. The first example embodiment mentioned above is a concrete example embodiment whereas the second example embodiment is a more generalized example embodiment.

### <3.1. Configuration of Communication Control Apparatus>

First, with reference to FIG. 5, an example of a configuration of a communication control apparatus 300 according to the second example embodiment is described. FIG. 5 is a block diagram illustrating an example of a schematic configuration of the communication control apparatus 300 according to the second example embodiment. Referring to FIG. 5, the communication control apparatus 300 includes an information acquisition unit (information acquirer) 310 and a selecting unit (selector) 320. For example, the communication control apparatus 300 is a DHCP server or a module for a DHCP server.

The information acquisition unit 310 acquires vendor-related information included in a DHCP discover message from a communication apparatus arranged in a subscriber network. The selecting unit 130 selects an IP address for the communication apparatus on the basis of the vendor-related information.

In an example, the information acquisition unit 310 and the selecting unit 320 operate like the information acquisition unit 120 and the selecting unit 130 according to the first example embodiment, respectively. In addition, for example, the above-mentioned communication apparatus operates like the CPE 20 according to the first example embodiment. These operations are mentioned above. Therefore, redundant description is omitted.

Note that the communication control apparatus 300 may further includes component(s) which operates like one or more components (for example, the receiving unit 110, the generating unit 140, and/or the transmitting unit 150) included in the DHCP server 100 according to the first example embodiment.

For example, the information acquisition unit 310 and the selecting unit 320 are implemented by a processor and a memory (and a program stored in the memory).

### <3.2. Flow of Processing>

Next, with reference to FIG. 6, an example of a flow of processing according to the second example embodiment is described. FIG. 6 is a sequential chart for describing an example of the flow of processing according to the second example embodiment.

The information acquisition unit 310 acquires vendor-related information included in a DHCP discover message from the communication apparatus arranged in the subscriber network (S401).

The selecting unit 320 selects an IP address for the above-mentioned communication apparatus on the basis of the above-mentioned vendor-related information (S403).

In the above, the second example embodiment has been described. According to the second example embodiment, it possible to assign a specific IP address to a specific communication apparatus (target apparatus) even when a DHCP server is not arranged in a subscriber network (for example, even when the DHCP server is arranged in a carrier network).

In the above, the example embodiments of the present invention have been described. The present invention is not limited to the example embodiments mentioned above, and various changes can be made within the scope of the present invention. The example embodiments mentioned above are merely examples, and it can be understood for a person skilled in the art that various modifications are possible for combinations of the example embodiments and combinations of the components and operation processes, and that such modifications are also within the scope of the present invention.

For example, the steps in the processing described herein need not be executed in the time series in accordance with the order illustrated in the sequential charts or the flowcharts. For example, the steps in processing may be executed in the different order from the order illustrated in the sequential charts or the flowcharts, or may be executed in parallel.

A method including processing of the components in the DHCP server or communication control apparatus described herein may be provided, and a program or program product for causing a processor to execute processing of the components may be provided. A non-transitory computer readable recording medium which records the program may be provided. It is needless to say that such method, program product, recording medium, and the like are also within the scope of the present invention.

The whole or part of the example embodiments disclosed above can be described as, but not limited to, the following supplementary notes.

### (Supplementary Note 1)

A communication control apparatus including:

a receiver that receives a dynamic host configuration protocol (DHCP) discover message from a communication apparatus arranged in a subscriber network; and

a processor that selects an internet protocol (IP) address for the communication apparatus on the basis of vendor-related information included in the DHCP discover message.

### (Supplementary Note 2)

The communication control apparatus according to Supplementary Note 1, wherein the vendor-related information includes vendor-specific information for identifying a vendor.

### (Supplementary Note 3)

The communication control apparatus according to Supplementary Note 1 or 2, wherein the vendor-related information includes a vendor class identifier.

### (Supplementary Note 4)

The communication control apparatus according to any one of Supplementary Notes 1 to 3, wherein the processor determines whether the communication apparatus is a target apparatus on the basis of the vendor-related information, and selects the IP address on the basis of the determination result.

### (Supplementary Note 5)

The communication control apparatus according to Supplementary Note 4, wherein the processor selects, as the IP address, a specific IP address associated with the communication apparatus when the communication apparatus is the target apparatus, and selects, as the IP address, an IP address within a predetermined range when the communication apparatus is not the target apparatus.

### (Supplementary Note 6)

The communication control apparatus according to any one of Supplementary Notes 1 to 5, wherein the processor generates a DHCP offer message including the selected IP address.

### (Supplementary Note 7)

The communication control apparatus according to any one of Supplementary Notes 1 to 6, wherein the communication control apparatus is a DHCP server or a module for a DHCP server.

### (Supplementary Note 8)

The communication control apparatus according to any one of Supplementary Notes 1 to 7, wherein the communication control apparatus is an apparatus arranged in a carrier network.

### (Supplementary Note 9)

A method including:

acquiring vendor-related information included in a DHCP discover message from a communication apparatus arranged in a subscriber network; and

selecting an IP address for the communication apparatus on the basis of the vendor-related information.

### (Supplementary Note 10)

A non-transitory computer readable recording medium storing a program that causes a processor to execute:

acquiring vendor-related information included in a DHCP discover message from a communication apparatus arranged in a subscriber network; and

selecting an IP address for the communication apparatus on the basis of the vendor-related information.

What is claimed is:

1. A communication control apparatus comprising:
a receiver that receives a dynamic host configuration protocol (DHCP) discover message from a communication apparatus arranged in a subscriber network; and
a processor that selects an internet protocol (IP) address for the communication apparatus on the basis of vendor-related information included in the DHCP discover message.

2. The communication control apparatus according to claim 1, wherein the vendor-related information includes vendor-specific information for identifying a vendor.

3. The communication control apparatus according to claim 1, wherein the vendor-related information includes a vendor class identifier.

4. The communication control apparatus according to claim 1, wherein the processor determines whether the communication apparatus is a target apparatus on the basis of the vendor-related information, and selects the IP address on the basis of the determination result.

5. The communication control apparatus according to claim 4, wherein the processor selects, as the IP address, a specific IP address associated with the communication apparatus when the communication apparatus is the target apparatus, and selects, as the IP address, an IP address within a predetermined range when the communication apparatus is not the target apparatus.

6. The communication control apparatus according to claim 1, wherein the processor generates a DHCP offer message including the selected IP address.

7. The communication control apparatus according to claim 1, wherein the communication control apparatus is a DHCP server or a module for a DHCP server.

8. The communication control apparatus according to claim 1, wherein the communication control apparatus is an apparatus arranged in a carrier network.

9. A method comprising:
acquiring vendor-related information included in a DHCP discover message from a communication apparatus arranged in a subscriber network; and
selecting an IP address for the communication apparatus on the basis of the vendor-related information.

10. A non-transitory computer readable recording medium storing a program that causes a processor to execute:
acquiring vendor-related information included in a DHCP discover message from a communication apparatus arranged in a subscriber network; and
selecting an IP address for the communication apparatus on the basis of the vendor-related information.
